(19) United States
(12) Patent Application Publication
(10) Pub. No.: US 2010/0052580 A1
(43) Pub. Date: Mar. 4, 2010

(54) Speed Control Module for Motor

(76) Inventor: Yu-Ta Tu, Taipei (TW)

Correspondence Address: David Shung, P.O. Box 10557, Taipei, 100, TW

(21) Appl. No.: 12/538,143

(22) Filed: Aug. 9, 2009

(30) Foreign Application Priority Data
Sep. 3, 2008 (TW) 097215826

(51) Int. Cl. H02P 23/00

(52) U.S. Cl. 318/400.04

(57) ABSTRACT

The speed control module includes a sensing element installed in a motor for detecting a position of magnet of rotor; a power switch connected to the motor for switching on/off control signals sent to the motor; a main controller connected to the power switch and sensing element for processing half-wave feedback signals from the sensing element and sending the signals to the motor via the power switch; and speed adjusting element connected to the main controller for receiving external information and providing to the main controller. When the motor is operating, the half-wave feedback signals of the sensing element vary because of continuous rotation of the magnet of rotor. The main controller outputs a three-phase voltage to change the magnetic field of the stator coil, so that the motor speed can be smooth and stable.

### BACKGROUND OF THE INVENTION

1. Technical Field

The invention generally relates to electrical motors, particularly to speed control of the motors.

2. Related Art

Electrical motors can transfer electric energy into mechanical energy. In modern industries, the electrical motors are usually needed to serve as a rotary power source. In general, a motor is essentially composed of a rotor and a stator. The rotor is induced to make rotation by means of the magnetic interaction between the rotor and stator.

To match various circumstances or loads such as electric vehicles, juicers or electric drills, rotation speed of motor must be controlled accurately. A conventional speed control method of motor uses time length of turning on of the stator coil. The higher the duty cycle is, the higher the rotation speed is. However, the control manner cannot make the rotation speed vary smoothly and stably.

### SUMMARY OF THE INVENTION

An object of the invention is to make the rotation speed vary smoothly by controlling magnetic field of the stator.

To accomplish the object, the invention includes a sensing element installed in a motor for detecting position of magnet of rotor; a power switch connected to the motor for switching on/off control signals sent to the motor; a main controller connected to the power switch and sensing element for processing half-wave feedback signals from the sensing element and sending the signals to the motor; and a speed adjusting element connected to the main controller for receiving external information and providing to the main controller.

When the motor is operating, the half-wave feedback signals of the sensing element vary because of continuous rotation of the magnet of rotor. The main controller outputs a three-phase voltage to change the magnetic field of the stator coil, so that the motor speed can be smooth and stable.

### BRIEF DESCRIPTION OF THE DRAWINGS

FIG. 1 is a block diagram of the speed control module of the invention.

### DETAILED DESCRIPTION OF THE INVENTION

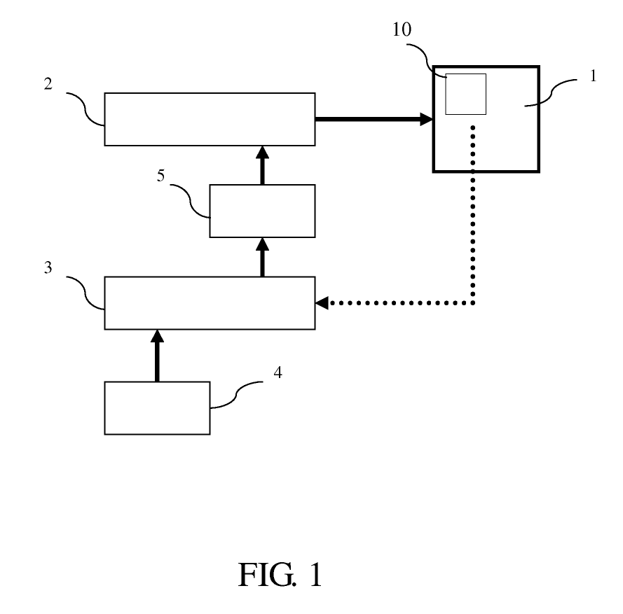

Referring to FIG. 1, the speed control module of the invention includes:

a sensing element 10 installed in a motor 1 for detecting a position of magnet of rotor;

a power switch 2 connected to the motor 1 for switching on/off control signals sent to the motor 1;

a main controller 3 connected to the power switch 2 and sensing element 10 for processing half-wave feedback signals from the sensing element 10 and sending the processed signals to the motor 1 via the power switch 2;

a speed adjusting element 4 connected to the main controller 3 for receiving external information and providing to the main controller 3 to control the motor speed; and

a buffer circuit 5 connected between the power switch 2 and the main controller 3 for buffering and amplifying signals from the main controller 3 and sending the signals to the power switch 3.

When the motor 1 is operating, the half-wave feedback signals of the sensing element 10 vary because of continuous rotation of the magnet of rotor (not shown). The main controller 3 receives requirements from the speed adjusting element 4 and the feedback signals from the sensing element 10 to output a three-phase voltage to change the magnetic field of the stator coil, so that the motor speed can be smooth and stable.

It will be appreciated by persons skilled in the art that the above embodiment has been described by way of example only and not in any limitative sense, and that various alterations and modifications are possible without departure from the scope of the invention as defined by the appended claims.

What is claimed is:

1. A speed control module for a motor comprising:
a sensing element installed in the motor for detecting a position of magnet of rotor;
a power switch connected to the motor;
a main controller connected to the power switch and the sensing element; and
a speed adjusting element 4 connected to the main controller;
wherein when the motor is operating, half-wave feedback signals of the sensing element vary because of continuous rotation of a magnet of a rotor, and the main controller outputs a three-phase voltage to change a magnetic field of a stator coil.

2. The speed control module for a motor of claim 1, further comprising a buffer circuit connected between the power switch and the main controller.
